(19) United States
(12) Patent Application Publication
(10) Pub. No.: US 2014/0118539 A1
(43) Pub. Date: May 1, 2014

(54) MEASUREMENT APPARATUS AND CONTROL METHOD THEREOF, AND COMPUTER-READABLE STORAGE MEDIUM

(71) Applicant: Canon Kabushiki Kaisha, Tokyo (JP)

(72) Inventors: Kazuyuki Ota, Yokohama-shi (JP); Hiroshi Yoshikawa, Kawasaki-shi (JP)

(73) Assignee: Canon Kabushiki Kaisha, Tokyo (JP)

(21) Appl. No.: 14/049,615

(22) Filed: Oct. 9, 2013

(30) Foreign Application Priority Data
Oct. 29, 2012 (JP) 2012-238357

(51) Int. Cl. G01C 3/08

(52) U.S. Cl. CPC G01C 3/08
USPC 348/140

(57) ABSTRACT

A dark region as a region on which light is not projected by a light projection unit is set. Disturbance light projected on a measurement target object is estimated from the set dark region. A captured image is corrected based on the estimated disturbance light. Distance to the measurement target object is executed from the corrected captured image.

### BACKGROUND OF THE INVENTION

1. Field of the Invention

The present invention relates to a technique for executing distance measurement by projecting pattern light onto a measurement target object, and capturing an image of the measurement target object projected with the pattern light.

2. Description of the Related Art

In a method of executing distance measurement by projecting pattern light onto a measurement target object, and capturing an image of the measurement target object projected with the pattern light, a problem is posed when disturbance light exists.

No problem is posed when a distance measurement environment is a dark room protected from any disturbance light. However, a dark room environment is costly. In a practical use, it is difficult to configure an environment which can perfectly remove disturbance light. For this reason, it is important to remove disturbance light so as to precisely attain distance measurement.

As a related art for removing disturbance light, an apparatus which includes a light-receiving unit which receives light projected by a light projection unit so as to measure an object distance, and another light-receiving unit arranged at a position where it cannot receive light projected by the light projection unit, and which acquires disturbance light at the time of light projection so as to correct a distance measurement light-receiving signal is known (Japanese Patent No. 3130559).

As another related art, the following method is known. light-shielding discs are respectively arranged on a pattern projection unit and light-receiving unit, measurement light is received when rotation phases of the discs are matched, and disturbance light is received when they are not matched. Furthermore, a field stop, which is arranged at an image plane conjugate position with the projection unit on the light-receiving side, receives disturbance light at the time of pattern projection, and removes the disturbance light from measurement light for distance measurement (Japanese Patent Laid-Open No. 2009-47488).

The conventional disturbance light removal method requires a dedicated mechanism on the light-receiving side so as to measure disturbance light, thus complicating the arrangement and requiring high cost.

### SUMMARY OF THE INVENTION

The present invention provides a measurement apparatus which can remove disturbance light by only a device on the projection side, and can attain precise distance measurement with low cost and a control method thereof, and a computer-readable storage medium.

In order to achieve the above object, a measurement apparatus according to the present invention comprises the following arrangement. That is, a measurement apparatus, comprising:

a setting unit configured to set a dark region on which no light is projected on a portion of a projection pattern for measuring a distance to a measurement target object;

an image capturing unit configured to capture an image of a measurement target object on which the projection pattern is projected;

an estimation unit configured to estimate disturbance light projected on the measurement target object from the dark region set by the setting unit; and

a distance calculation unit configured to measure the distance to the measurement target object based on the disturbance light estimated by the estimation unit and a captured image captured by the image capturing unit.

According to the present invention, disturbance light can be removed by only a device on the projection side, and precise distance measurement can be attained with low cost.

Further features of the present invention will become apparent from the following description of exemplary embodiments (with reference to the attached drawings).

### BRIEF DESCRIPTION OF THE DRAWINGS

FIG. 1 is a block diagram showing the arrangement of a distance measurement apparatus according to the first embodiment;

FIG. 2A is a view for explaining a complementary pattern projection method according to the first embodiment;

FIG. 2B is a view for explaining the complementary pattern projection method according to the first embodiment;

FIG. 2C is a view for explaining the complementary pattern projection method according to the first embodiment;

FIG. 3 is a view for explaining an intersection coordinate calculation in the complementary pattern projection method according to the first embodiment;

FIG. 4 is a flowchart showing the processing sequence of the distance measurement apparatus according to the first embodiment;

FIG. 5 is a view for explaining a dark region setting method according to the first embodiment;

FIG. 6 is a view for explaining a disturbance light removed image generation method according to the first embodiment;

FIG. 7 is a flowchart showing the processing sequence of the distance measurement apparatus according to the first embodiment;

FIG. 8A is an explanatory view of a phase shift method according to the first embodiment;

FIG. 8B is an explanatory view of the phase shift method according to the first embodiment;

FIG. 9A is a view for explaining a dark region setting method according to the second embodiment;

FIG. 9B is a view for explaining the dark region setting method according to the second embodiment;

FIG. 10 is a view for explaining a dark region setting method according to the third embodiment;

FIG. 11A is a view for explaining a practical example of the dark region setting method according to the first to third embodiments; and

FIG. 11B is a view for explaining a practical example of the dark region setting method according to the first to third embodiments.

### DESCRIPTION OF THE EMBODIMENTS

Embodiments of the present invention will be described in detail hereinafter with reference to the drawings.

### First Embodiment

The first embodiment of a distance measurement apparatus which adopts a disturbance light removal method according to the present invention will be described below.

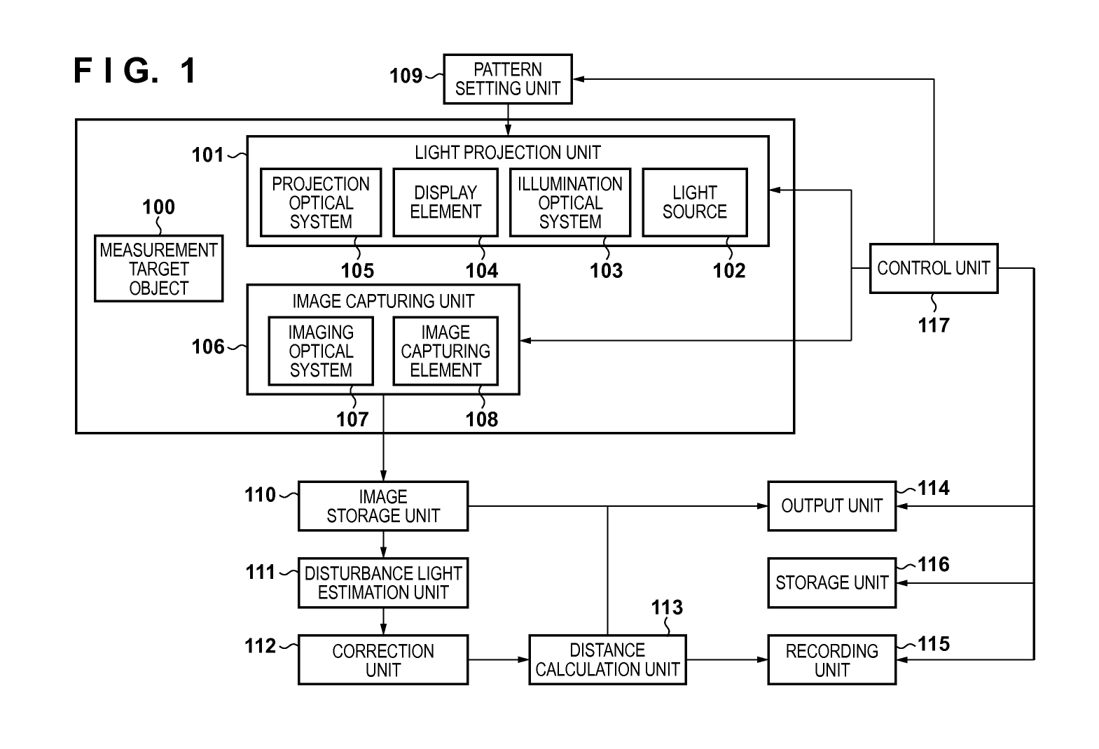

FIG. 1 shows the arrangement of the distance measurement apparatus according to the first embodiment.

A measurement target object 100 is an object to be measured by the measurement apparatus of the first embodiment.

A light projection unit 101 projects pattern light onto the measurement target object 100. The light projection unit 101 includes a light source 102, illumination optical system 103, display element 104, and projection optical system 105. As the light source 102, various light-emitting elements such as a halogen lamp and LED can be used. The illumination optical system 103 has a function of guiding light emitted by the light source 102 to the display element 104. As the display element 104, a transmission type LCD, reflection type LCOS/DMD, or the like is used. The display element 104 has a function of spatially controlling a transmittance or reflectance when it guides light coming from the illumination optical system 103 to the projection optical system 105. The projection optical system 105 is configured to image the display element 104 at a specific position of the measurement target object 100.

Note that the first embodiment shows the arrangement of a projection apparatus including the display element 104 and projection optical system 105. Alternatively, a projection apparatus including spot light and a two-dimensional scanning optical system may be used.

An image capturing unit 106 captures an image of the measurement target object 100. The image capturing unit 106 includes an imaging optical system 107 and image capturing element 108. As the image capturing element 108, various photoelectric conversion elements such as a CMOS sensor and CCD sensor are used.

A pattern setting unit 109 sets a pattern to be projected onto the measurement target object 100 by the light projection unit 101. The pattern setting unit 109 can set a dark region where light is not projected by the light projection unit 101 so as to calculate disturbance light during distance measurement. The dark region can be realized by controlling light transmitted through the display element 104. A practical dark region setting method will be described later.

An image storage unit 110 stores an image captured by the image capturing unit 106, and has a capacity enough to store a plurality of images.

A disturbance light estimation unit 111 estimates disturbance light projected onto the measurement target object 100 during measurement based on an image luminance of the dark region set by the pattern setting unit 109 from an image stored in the image storage unit 110. A practical disturbance light estimation method will be described later.

A correction unit 112 generates correction information used to execute correction for removing (eliminating) disturbance light, which is estimated by the disturbance light estimation unit 111 and is to be projected onto the measurement target object 100 during measurement. Note that as the disturbance light removal method, a method of applying correction to remove actually projected disturbance light to a processing target image or a method of correcting luminance information itself of disturbance light which influences distance measurement may be used. The practical disturbance light removal method will be described later.

A distance calculation unit 113 calculates a distance to the measurement target object 100 from a correction result (correction information) of the correction unit 112.

An output unit 114 outputs distance information as the calculation result of the distance calculation unit 113. Also, the output unit 114 outputs an image stored in the image storage unit 110. The output unit 114 includes a monitor used to display distance information as the calculation result and an image, a printer, and the like.

A recording unit 115 records distance information as the calculation result of the distance calculation unit 113. The recording unit 115 includes a hard disk, flash memory, and the like used to record various data including the distance information as the calculation result.

A storage unit 116 stores information of the dark region set by the pattern setting unit 109, the distance information calculated by the distance calculation unit 113, and the like. Also, the storage unit 116 stores control information of a control unit 117, and the like.

The control unit 117 controls operations of the light projection unit 101, image capturing unit 106, pattern setting unit 109, output unit 114, recording unit 115, and storage unit 116. The control unit 117 includes a CPU, RAM, ROM which stores various control programs, and the like. Various programs stored in the ROM include a control program required to control pattern light to be projected by the light projection unit 101, a control program required to control the image capturing unit 106, a control program required to control the pattern setting unit 109, and the like. Also, various programs may include a control program required to control the output unit 114, a control program required to control the recording unit 115, and the like.

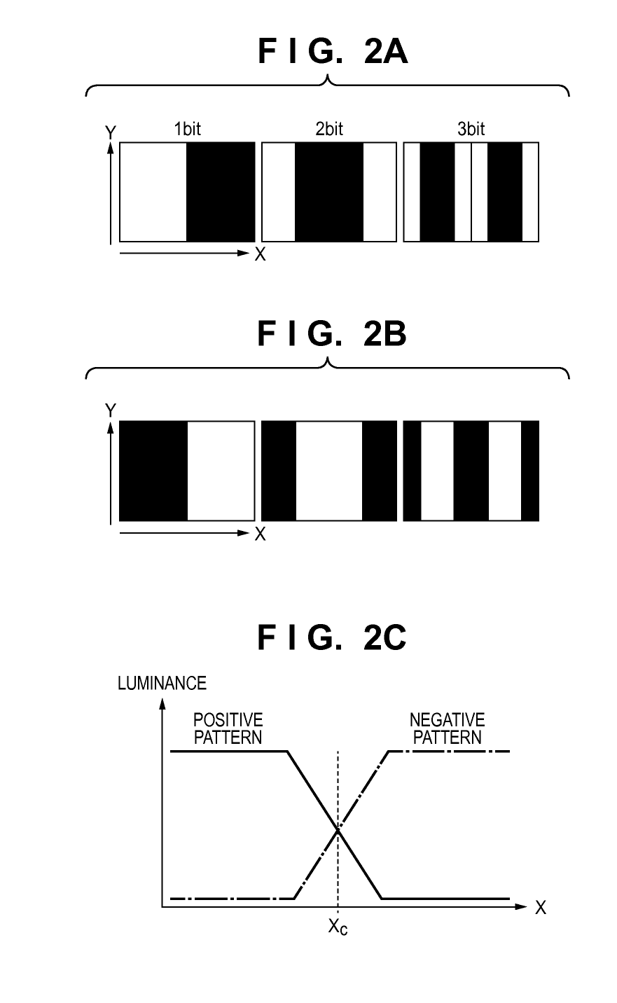

Next, a problem posed when disturbance light is superposed on measurement pattern light will be described below. FIGS. 2A to 2C are views for explaining a complementary pattern projection method in a spatial encoding method. The spatial encoding method will be described first. In the spatial encoding method, pattern light including a plurality of line beams is projected onto a measurement target object, and a line number is identified using encoding in a time direction in a space. A correspondence relationship between an exit angle of pattern light and an incident angle to the image capturing element is calibrated in advance, and distance measurement is executed based on the principle of triangulation. Line numbers of a plurality of line beams are identified using, for example, a gray code method or the like. FIG. 2A shows patterns of the gray code method, and expresses gray code patterns of 1 bit, 2 bits, and 3 bits in turn from the left. A description of gray code patterns of 4 bits and subsequent bits will not be given.

In the spatial encoding method, images are captured while projecting the gray code patterns shown in FIG. 2A in turn onto the measurement target object. Then, binary values of respective bits are calculated from captured images. More specifically, when an image luminance value of a captured image is not less than a threshold in each bit, a binary value of that region is 1. On the other hand, when an image luminance value of the captured image is less than the threshold, a binary value of that region is 0. Binary values of respective bits are arranged in turn to form a gray code of that region. Then, the gray code is converted into a spatial code to execute distance measurement.

As a threshold determination method, for example, a complementary pattern projection method is used. That is, in this method, negative patterns shown in FIG. 2B, in each of which black and white portions are inverted with respect to the gray code patterns (to be referred to as positive patterns hereinafter) shown in FIG. 2A, are projected onto the measurement target object to capture images. Then, an image luminance value of the negative patterns is determined as a threshold.

Normally, the spatial encoding method has an ambiguity of a position by the width of a least significant bit. However, by detecting a boundary position at which the binary value is switched from 0 to 1 or vice versa on a captured image, the ambiguity can be reduced to be smaller than the bit width, thus enhancing distance measurement precision.

FIG. 2C shows a luminance change at a boundary position at which the binary value is switched. Ideally, luminance rising and falling edges are generated in an impulse manner, but form moderate lines or curves due to the influences of blurring of pattern light, a reflectance of an object (measurement target object), and the like. Therefore, it is important to precisely calculate an intersection position xc of positive and negative patterns corresponding to a switching position of the binary value.

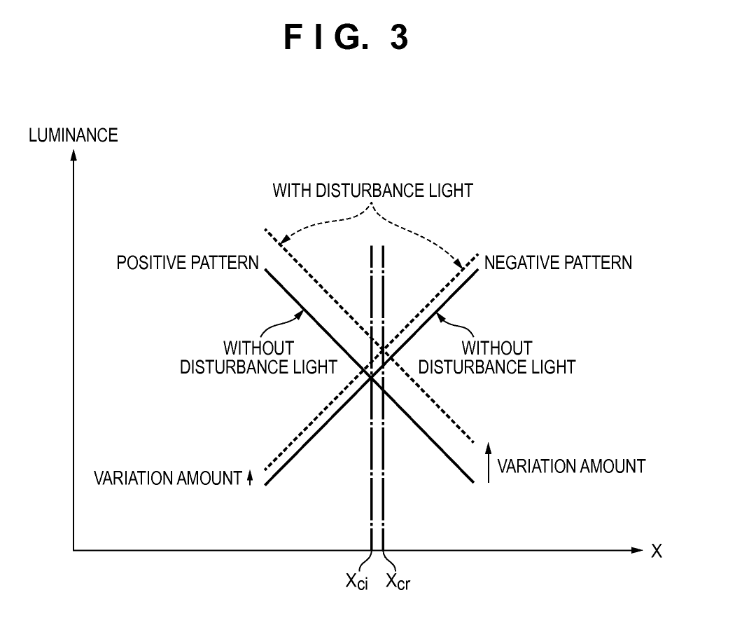

FIG. 3 is a view for explaining intersection coordinate calculations between positive and negative pattern images by the spatial encoding method under the assumptions with and without uniform disturbance light. In FIG. 3, a luminance change of a positive pattern and that of a negative pattern without any disturbance light are expressed by solid lines, and a luminance change of the positive pattern and that of the negative pattern with disturbance light are expressed by dotted lines.

Without any disturbance light, an intersection between the positive and negative patterns is a position of a point x_{ci}. On the other hand, with disturbance light, the luminance of the positive pattern rises, and that of the negative pattern also rises. However, since the positive and negative patterns are not captured at the same time, disturbance light amounts are not always the same. For this reason, an intersection between the positive and negative patterns is a position of a point x_{cr}, and the intersection position is deviated compared to the case without any disturbance light. Thus, the disturbance light impairs the distance measurement precision.

In this case, especially, the spatial encoding has been exemplified. However, the present invention is not limited to this. In a distance measurement apparatus, pattern light of a desired light amount is generally projected onto a measurement target object. In such situation, disturbance light is added to the pattern light, and light of the desired light amount or more is projected onto the measurement target object when an image is captured (captured image), thus posing a problem for the distance measurement apparatus. That is, not only in the spatial encoding method but also in general methods for projecting pattern light, the disturbance light impairs the distance measurement precision.

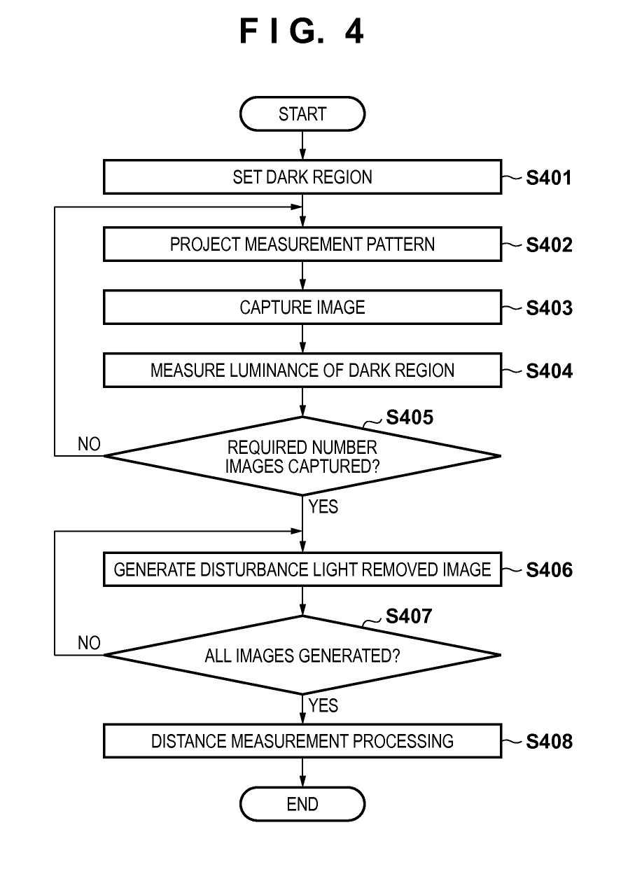

The processing sequence of the distance measurement apparatus according to the present invention will be described below with reference to FIG. 4.

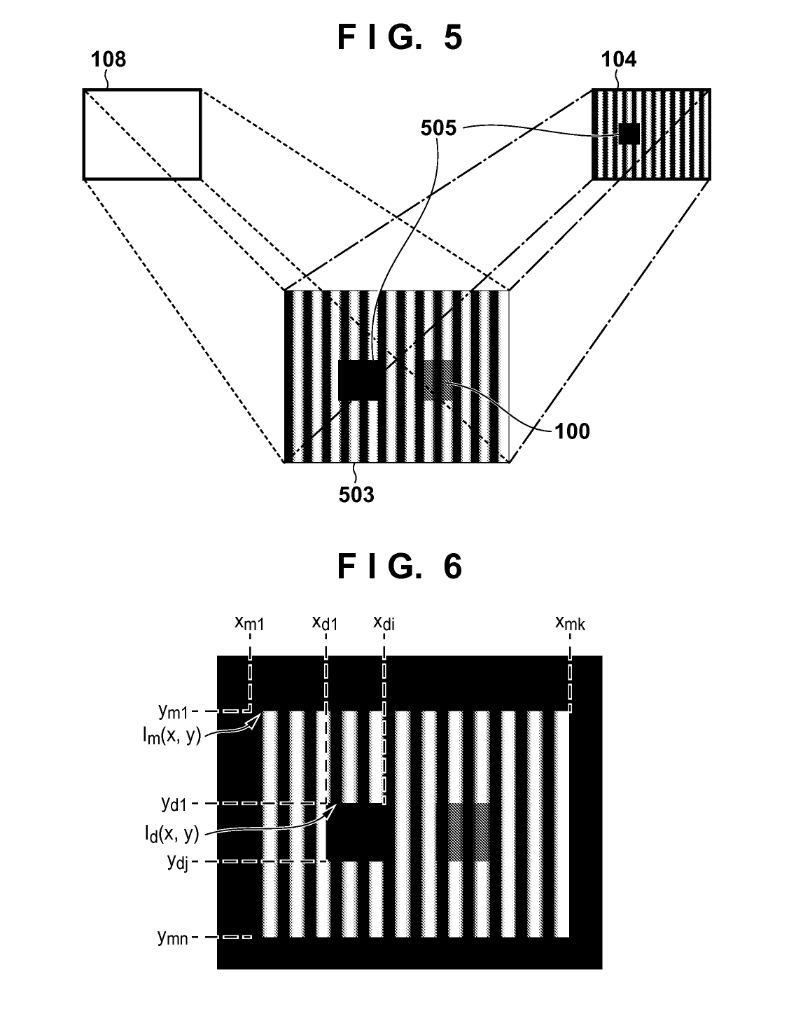

When the operation of the distance measurement apparatus is started, the pattern setting unit 109 sets a dark region (step S401). As a dark region setting method, for example, as shown in FIG. 5, when stripe pattern light is projected from the display element 104 of the light projection unit 101, a region where no stripe pattern light is projected is generated on the display element 104. Thus, a dark region 505 is set on a measurement surface 503 for the image capturing element 108 around a region of the target measurement object 100 in a captured image on the measurement surface 503. As the position of the dark region, a region around the measurement target object 100 may be manually set, or the distance measurement apparatus may automatically recognize the measurement target object 100 to set the dark region.

The dark region setting method will be described below. In case of a manual setting, a dark region is designated based on a captured image which is obtained by capturing an image of the measurement target object and is output to the output unit 114. As a dark region designation method, for example, the output unit 114 has a touch panel function, and a rectangular region is designated on the output captured image with the finger or a pointing member. As another dark region designation method, for example, when the captured image output to the output unit 114 is designated with the finger or pointing member, a coordinate value of the designated position is output. Then, four points are designated to form a rectangular region, thus determining the dark region by the four output coordinate values.

In case of an automatic setting, a dark region is designated based on a recognition result of the measurement target object. An automatic setting example of the dark region will be described below. Initially, the presence of the measurement target object is recognized. As a recognition method, an image is captured when no measurement target object is placed on the measurement surface, and an image difference from an image captured when the measurement target object is placed is calculated, thereby recognizing the measurement target object. As another measurement target object recognition method, two-dimensional appearances of the measurement target object on captured images are learned in advance based on images obtained by capturing the measurement target object at various positions and orientations in advance, thus generating a dictionary. Then, by collating that dictionary with an image captured when the dark region is set, the measurement target object is recognized. In case of the latter recognition method, when the dictionary is generated to include information of angles in an in-plane rotation direction, those in a depth rotation direction, and the like of the measurement target object, an approximate orientation of the measurement target object can be detected from a captured image.

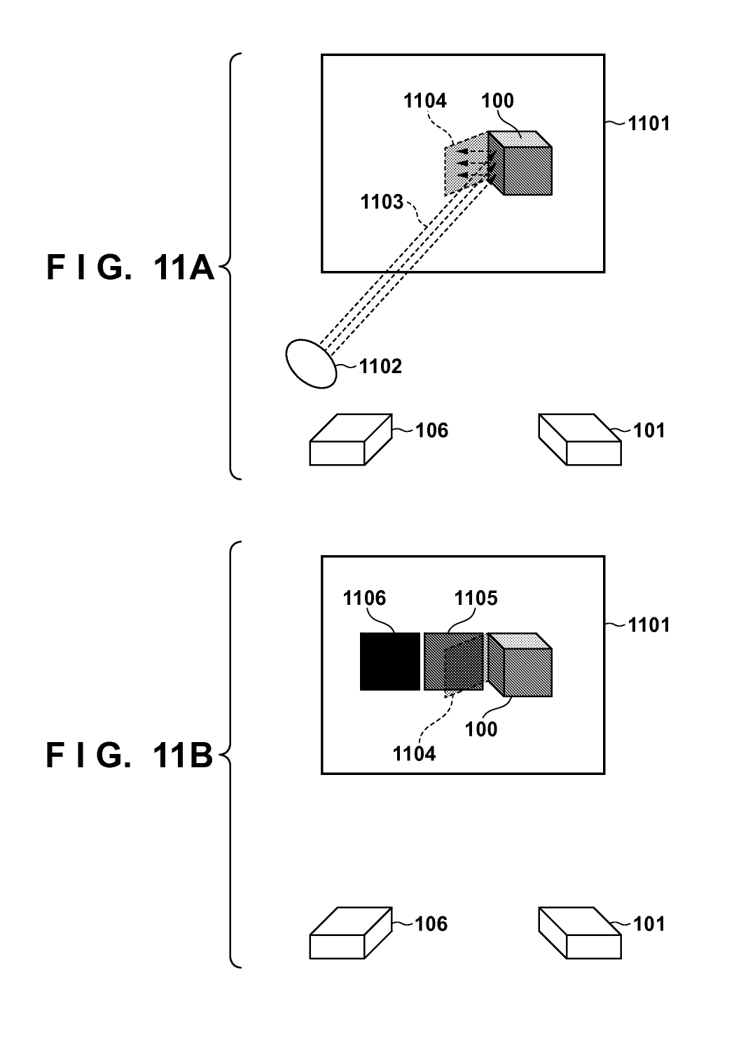

For this reason, if the measurement target object has a planar portion, a direction in which the planar portion directs can be determined. For example, if a position of a disturbance light source 1102 as a main cause of disturbance light is approximately detected, as shown in FIG. 11A, a projection direction of disturbance light 1103 is determined. When the disturbance light 1103 is projected onto the planar portion, a region where secondary reflected light is cast (secondary reflection region 1104) is often generated around the measurement target object 100 on a measurement surface 1101. This secondary reflection region 1104 can be judged from the projection direction of the disturbance light source 1102 and a direction in which the plane of the measurement target object 100 directs when viewed from the image capturing unit 106. Thus, as shown in FIG. 11B, the secondary reflection region 1104 is estimated to determine a region which is inappropriate to be set as a dark region (NG dark region 1105), thus automatically setting a region which is appropriate to be set as a dark region (OK dark region 1106). When the projection direction of the disturbance light is not determined, a broader region which may be influenced by the secondary reflection region may be set based on the detected planar portion, thus coping with such case.

Note that the manual/automatic setting of the dark region in FIGS. 11A and 11B is also applicable to the arrangement of the second and third embodiments to be described later. Also, the shape of the dark region is not limited to a rectangular shape, and an arbitrary shape can be used according to the intended application and purpose.

After the dark region is set, the light projection unit 101 then projects measurement pattern light required to execute distance measurement onto the measurement target object 100 (step S402).

When the pattern light is projected, the image capturing unit 106 captures a captured image region including the measurement target object 100 (step S403).

After the captured image region including the measurement target object 100 is captured, the disturbance light estimation unit 111 measures an image luminance value of the dark region in the captured image region (captured image region) (step S404).

After the image luminance value of the dark region is measured, the control unit 117 determines whether or not images required to execute distance measurement have been captured by projecting the measurement pattern light. If the control unit 117 determines that images required to execute distance measurement have been captured (YES in step S405), the process advances to step S406. On the other hand, if the control unit 117 determines that images required to execute distance measurement have not been captured yet (NO in step S405), the process returns to step S402, and the light projection unit 101 projects the next measurement pattern light (step S405).

After the images required to execute distance measurement have been captured, the correction unit 112 generates an image in which disturbance light is removed from the captured image (to be referred to as a disturbance light removed image hereinafter) (step S406). The disturbance light removed image is generated using values obtained by subtracting the image luminance values of the dark region from luminance values of an image captured by projecting the measurement pattern light under the assumption that the distribution of disturbance light is uniform. An example of a practical generation method will be described below with reference to FIG. 6.

Let x_{d1} to x_{di} be x coordinates within a range of the dark region and y_{d1} to y_{dj} be y coordinates within the range of the dark region in an image captured by projecting measurement pattern light. Let xₘ₁ to xₘₖ be x coordinates within a range of a region on which the measurement pattern light is projected and yₘ₁ to yₘₙ be y coordinates within the range of the region on which the measurement pattern light is projected in the image captured by projecting the measurement pattern light. Assume that the coordinates of the range of the region on which the measurement pattern light is projected do not overlap those of the range of the dark region. Also, let Iₘ(x, y) be a luminance value of each pixel of the region on which the measurement pattern light is projected. Let I_{d}(x, y) be a luminance value of each pixel of the dark region.

Since the measurement pattern light is not projected onto the dark region, a luminance value of each pixel of the dark region is that of the pixel which is influenced by only disturbance light. For example, if an average value of luminance values of all pixels of the dark region is used as a representative value I_{dave} of luminance values of pixels which are influenced by only the disturbance light, the representative value I_{dave} is given by:

$${I}_{dave} = {\sum }_{x = {x}_{d 1}}^{{x}_{di}} {\sum }_{y = {y}_{d 1}}^{{y}_{dj}} {I}_{d} ( x , y ) / ( i \times j ) \qquad ( 1 )$$

Then, a luminance value Iᵣ(x, y) of each pixel of the disturbance light removed image is given by:

Iᵣ(x,y)=Iₘ(x,y)−I_{dave} (2)

In this manner, the disturbance light removed image is generated.

After the disturbance light removed image is generated, the control unit 117 then determines whether or not disturbance light removed images are generated from all images captured by projecting the measurement pattern light (step S407). If the control unit 117 determines that disturbance light removed images are generated from all images captured by projecting the measurement pattern light (YES in step S407), the process advances to step S408. If the control unit 117 determines that disturbance light removed images are not generated from all images captured by projecting the measurement pattern light (YES in step S407), the process returns to step S406, and the next disturbance light removed image is generated.

After the disturbance light removed images are generated from all images captured by projecting the measurement pattern light), the distance calculation unit 113 executes distance measurement processing using the disturbance light removed images (step S408).

By setting the dark region in this manner, a region other than the measurement region is effectively used, and disturbance light can be measured at the same timing as a measurement timing.

The aforementioned processing adopts the method of adjusting the measurement pattern light projection timing and disturbance light measurement timing to the same timing, but the region on which the measurement pattern light is projected is different from the dark region where disturbance light is measured.

A method of removing disturbance light based on a change amount of the disturbance light in a time direction in consideration of the difference between the region on which the measurement pattern light is projected and the dark region although the measurement pattern light projection timing and disturbance light measurement timing are different will be described below.

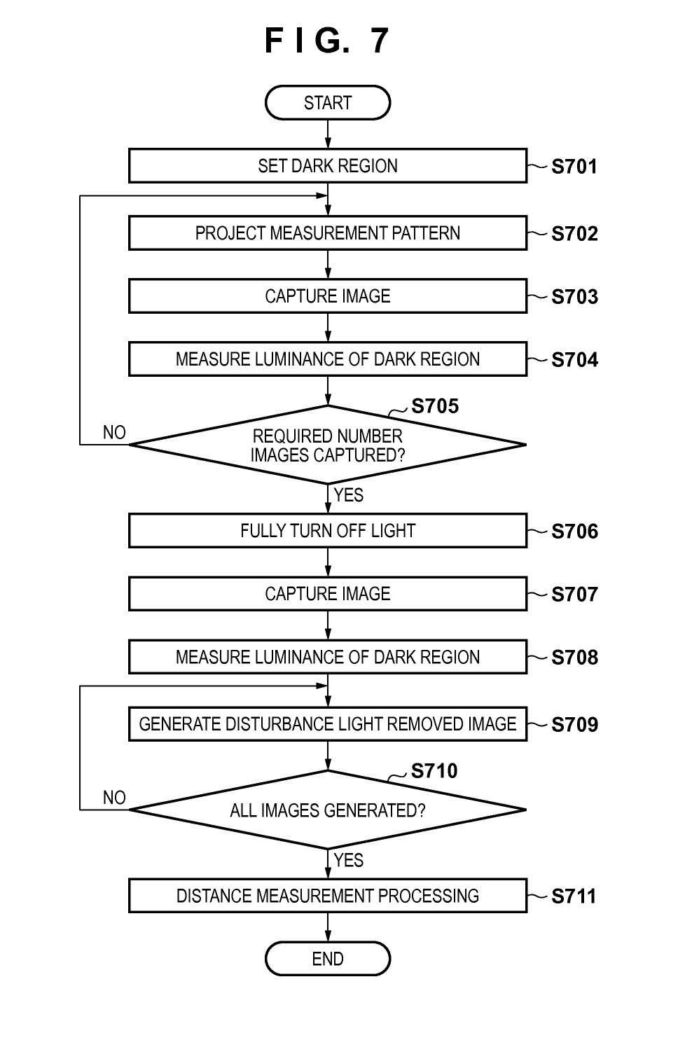

Since the arrangement of the distance measurement apparatus is the same as that shown in FIG. 1, a description thereof will not be repeated. FIG. 7 shows the processing sequence. Since steps S701 to S705 respectively correspond to steps S401 to S405 in FIG. 4, a detailed description thereof will not be repeated. After images required to execute distance measurement have been captured by projecting measurement pattern light in step S705, the light projection unit 101 is fully turned off (step S706).

After the light projection unit 101 is fully turned off, the image capturing unit 106 then captures a captured image region including the measurement target object 100 (step S707).

After the captured image region including the measurement target object 100 is captured, the disturbance light estimation unit 111 measures an image luminance value of the dark region (step S708).

After the image luminance value of the dark region is measured, the correction unit 112 generates a disturbance light removed image from each captured image (step S709). In case of this method, the disturbance light removed image is generated using an image captured by projecting the measurement pattern light and that captured when the light projection unit 101 is fully turned off. An example of a practical generation method will be described below. Since the region on which the measurement pattern light is projected and the dark region are the same as those in FIG. 6, and luminance values of pixels of the region on which the measurement pattern light is projected and those of pixels of the dark region are the same as those in FIG. 6, a description thereof will not be repeated.

Let I_{mb}(x, y) be a luminance value of each pixel of the measurement region in the image captured when the light projection unit 101 is fully turned off. Also, let I_{db}(x, y) be of the dark region in the image captured when the light projection unit 101 is fully turned off. Then, if an average value of luminance values of all pixels of the dark region in the image captured when the light projection unit 101 is fully turned off is used as a representative value I_{dbave} of luminance values of pixels which are influenced by only the disturbance light, the representative value I_{dbave} is given by:

$${I}_{dbave} = {\sum }_{x = {x}_{d 1}}^{{x}_{di}} {\sum }_{y = {y}_{d 1}}^{{y}_{dj}} {I}_{db} ( x , y ) / ( i \times j ) \qquad ( 3 )$$

Then, a luminance value Iᵣ(x, y) of each pixel of the disturbance light removed image is given by:

Iᵣ(x,y)=Iₘ(x,y)−I_{mb}(x,y)×I_{dave}/I_{dave} (4)

Note that I_{dave} is the same value as that calculated using equation (1). In this manner, the disturbance light removed image is generated.

Since steps S710 and S711 are the same as steps S407 and S408 in FIG. 4, a description thereof will not be repeated.

In this manner, disturbance light of the measurement region can be estimated based on a change amount of the disturbance light in a time direction in consideration of the difference between the region on which the measurement pattern light is projected and the dark region where the disturbance light is measured.

In the aforementioned example, the disturbance light removed image is generated. Alternatively, distance measurement processing may be executed based on luminance information obtained by removing disturbance light from measurement pattern light without generating any disturbance light removed image. More specifically, luminance information of a distance required portion of a captured image A (a partial image in the captured image A) is directly corrected to obtain a captured image A1. That is, the captured image A is converted into the captured image A1.

In the above example, one image is captured while the light projection unit 101 is fully turned off to remove disturbance light. Alternatively, a plurality of images may be captured while the light projection unit 101 is fully turned off to obtain disturbance light removed luminance information. Especially, when disturbance light has a periodicity, since periodicity components can be calculated from a plurality of captured images, it is effective to capture a plurality of images in such case.

The above example has explained the case using the spatial encoding method. Alternatively, the present invention is also applicable to other distance measurement method with pattern light projection.

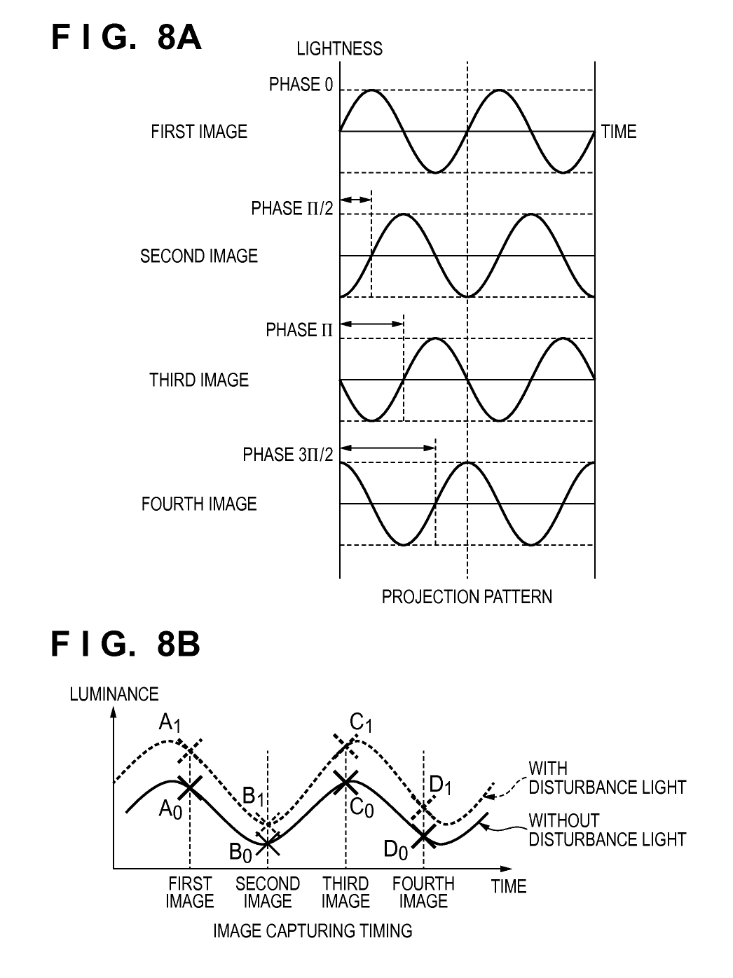

FIGS. 8A and 8B are explanatory views of a phase shift method. FIG. 8A shows timings of patterns to be projected, and FIG. 8B sows luminance values of captured images at image capturing timings. In FIG. 8B a luminance change without any disturbance light is expressed by the solid curve, and that with disturbance light is expressed by the dotted curve. In the phase shift method, stripe pattern light, lightness of which changes in a sinusoidal pattern, is projected onto the measurement target object 100, and the image capturing unit 106 captures an image while shifting the phase of the stripe pattern light by π/2. A total of four images are captured until the phase reaches 2π. Letting A₀, B₀, C₀, and D₀ be luminance values at the same position on the four images, a phase α of a pattern at that position is expressed by:

$$α = {tan}^{- 1} \frac{{D}_{0} - {B}_{0}}{{A}_{0} - {C}_{0}} \qquad ( 5 )$$

This phase undergoes distance measurement using the principle of triangulation. However, when disturbance light is projected at image capturing timings, the luminance values at the same position on the four images are changed like A₁, B₁, C₁, and D₁, as indicated by the dotted curve in FIG. 8B. For this reason, the phase to be calculated is changed, and the distance measurement result suffers an error. Therefore, by removing disturbance light, distance measurement can be executed with high precision.

In a light-section method or multi-line shift method as well, since pattern light is similarly projected and images are captured at different timings, disturbance light causes an error in the distance measurement result. For this reason, by removing disturbance light, distance measurement can be executed with high precision.

As described above, according to the first embodiment, the dark region where no pattern light is projected is set on a region outside the measurement region, and disturbance light is removed based on the image luminance value of that dark region, thus executing distance measurement. In this way, disturbance light can be measured without arranging any arrangement for measuring disturbance light on the light-receiving side, thus improving the distance measurement precision. Since the dark region can be manually/automatically set at an appropriate position, more precise distance measurement can be executed.

### Second Embodiment

### Set Dark Region Using Outer Side of Pattern Light

The second embodiment of a distance measurement apparatus using the disturbance light removal method according to the present invention will be described below.

Since the arrangement of the distance measurement apparatus is the same as that shown in FIG. 1, a description thereof will not be repeated. In the first embodiment, a dark region is set by generating a region where no pattern light is projected by a light projection unit 101 on a display element 104, as shown in FIG. 5. By contrast, in the second embodiment, a region captured by an image capturing element 108 of an image capturing unit 106 and that projected by the display element 104 of the light projection unit 101 are arranged to partially overlap each other, thus setting a dark region which falls outside the region on which pattern light is projected and falls within the region where an image is captured.

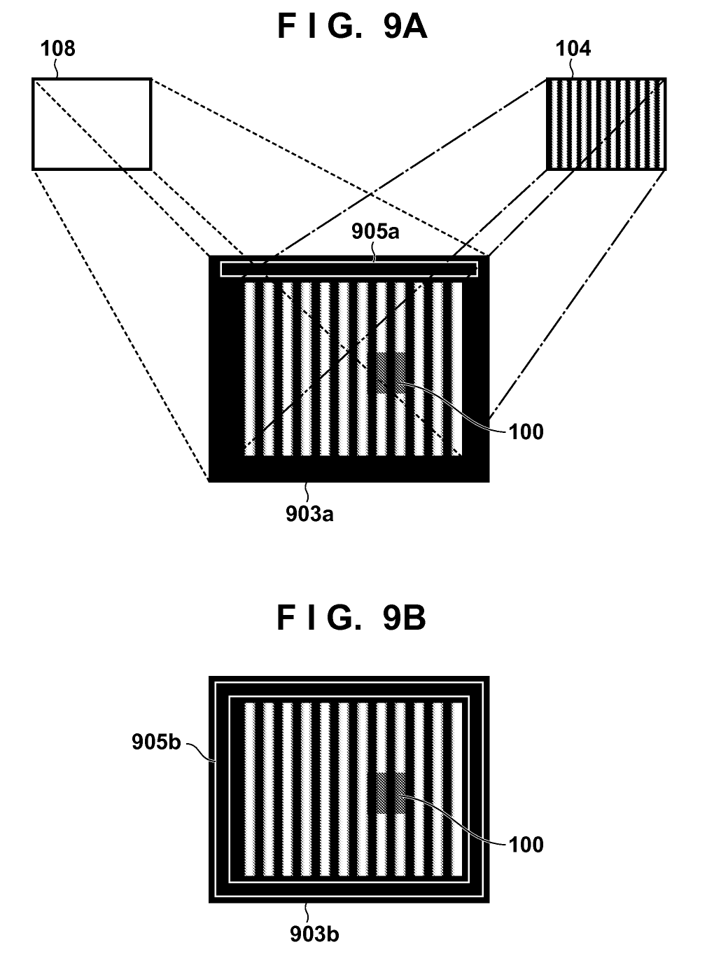

FIGS. 9A and 9B are views showing an example of a dark region setting method. FIG. 9A shows an example in which a region of an upper portion of a measurement surface 903a on which a region captured by the image capturing element 108 of the image capturing unit 106 and a region projected by the display element 104 of the light projection unit 101 overlap each other is set as a dark region 905a. Since no pattern light is projected onto the dark region 905a, disturbance light can always be measured.

FIG. 9B shows an example in which a dark region 905b is set to surround the region on which pattern light is projected. In this example, since the area of the dark region is larger than the dark region 905a, a processing time is prolonged, but disturbance light of the measurement region can be estimated more easily.

Since the processing sequence is the same as that of the first embodiment, a description thereof will not be repeated.

As described above, according to the second embodiment, in addition to the effects described in the first embodiment, the dark region can be set without any control for generating a region on which no pattern light is projected on the display element.

### Third Embodiment

### Use Plural Dark Regions

The third embodiment of a distance measurement apparatus using the disturbance light removal method of the present invention will be described below.

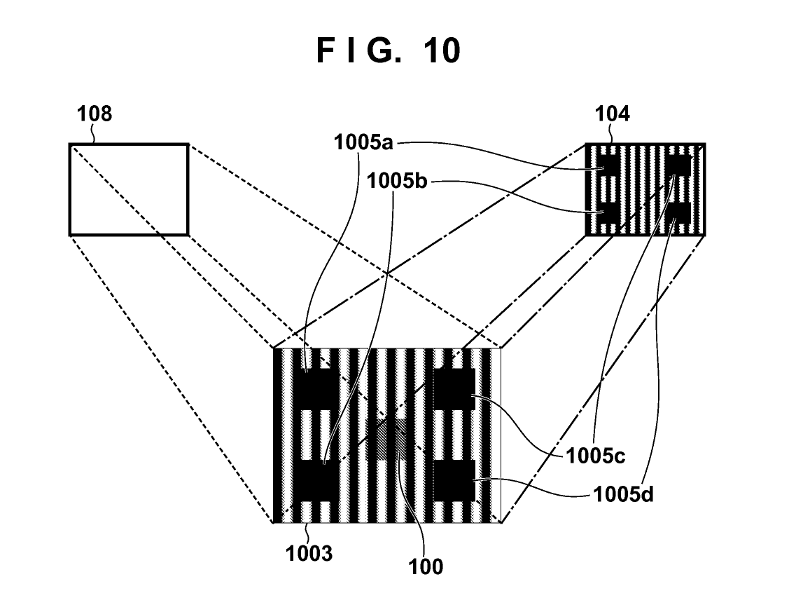

Since the arrangement of the distance measurement apparatus is the same as that shown in FIG. 1, a description thereof will not be repeated. In the first and second embodiments, a dark region is set at one position. By contrast, in the third embodiment, a plurality of dark regions are set in a region captured by an image capturing element 108 of an image capturing unit 106, as shown in FIG. 10. That is, a plurality of dark regions are used. Although the processing sequence is the same as that in the first embodiment, since a method of generating a disturbance light removed image is different, it will be described below.

A case will be explained below wherein four dark regions are set, as shown in FIG. 10. Let I_{daave}, I_{dbave}, I_{dcave}, and I_{ddave} be average values of luminance values of all pixels of dark regions 1005a, 1005b, 1005c, and 1005d. Let Dₘₐ(x, y), D_{mb}(x, y), D_{mc}(x, y), and D_{md}(x, y) be distances between each pixel of a region on which measurement pattern light is projected and barycenters of the respective dark regions. Also, Dₘₐₗₗ (x, y) be a sum total of the distances between each pixel of the region on which measurement pattern light is projected and barycenters of the respective dark regions. Let Iₘ(x, y) be a luminance value of each pixel of the region on which measurement pattern light is projected. When the average values of the luminance values of all the pixels of the dark regions are weighted-distributed according to the distances between each pixel of the region on which measurement pattern light is projected and barycenters of the respective dark regions, a luminance value Iᵣ(x, y) of each pixel of a disturbance light removed image is given by:

Iᵣ(x,y)=Iₘ(x,y)−((I_{daave}×Dₘₐ(x,y)/Dₘₐₗₗ(x,y))+(I_{daave}×D_{mb}(x,y)/Dₘₐₗₗ(x,y))+(I_{dcave}×D_{mc}(x,y)/Dₘₐₗₗ(x,y))+(I_{ddave}×D_{md}(x,y)/Dₘₐₗₗ(x,y))) (6)

As described above, a disturbance light removed image is generated.

In this manner, disturbance light of the measurement region can be estimated using the plurality of dark regions.

The method of calculating a luminance value of each pixel of the disturbance light removed image is not limited to this method, and any other methods can be used as long as they use a plurality of dark regions.

As described above, according to the third embodiment, in addition to the effects described in the first embodiment, since a plurality of dark regions can be set, more appropriate dark regions can be set according to a measurement environment in which, for example, a measurement target object is relatively small. Thus, precise distance measurement can be executed.

### Fourth Embodiment

An embodiment which arbitrarily combines the first to third embodiments can be implemented. For example, in the arrangement of the second embodiment, a plurality of dark regions may be manually/automatically set.

Note that the present invention can also be implemented by executing the following processing. That is, in this processing, software (program) which implements the functions of the aforementioned embodiment is supplied to a system or apparatus via a network or various storage media, and a computer (or a CPU, MPU, or the like) of that system or apparatus reads out and executes the program.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-238357, filed Oct. 29, 2012, which is hereby incorporated by reference herein in its entirety.

What is claimed is:

1. A measurement apparatus, comprising:
a setting unit configured to set a dark region on which no light is projected on a portion of a projection pattern for measuring a distance to a measurement target object;
an image capturing unit configured to capture an image of a measurement target object on which the projection pattern is projected;
an estimation unit configured to estimate disturbance light projected on the measurement target object from the dark region set by said setting unit; and
a distance calculation unit configured to measure the distance to the measurement target object based on the disturbance light estimated by said estimation unit and a captured image captured by said image capturing unit.

2. The apparatus according to claim 1, further comprising:
a correction unit configured to correct the captured image based on the disturbance light estimated by said estimation unit,
wherein said distance calculation unit measures the distance to the measurement target object from the captured image corrected by said correction unit.

3. The apparatus according to claim 1, wherein said estimation unit calculates luminance information indicating disturbance light included in the captured image using the dark region set by said setting unit, and estimates disturbance light of a region including the measurement target object in the captured image.

4. The apparatus according to claim 1, wherein said estimation unit estimates a distribution of disturbance light included in the captured image using a plurality of dark regions set by said setting unit, and estimates disturbance light of a region including the measurement target object in the captured image.

5. The apparatus according to claim 1, wherein said setting unit sets the dark region on a region except for a region where secondary reflected light is cast around the measurement target object in the captured image.

6. The apparatus according to claim 1, further comprising:
a recognition unit configured to recognize the measurement target object from the captured image,
wherein said setting unit sets the dark region on a region except for a region of the measurement target object recognized by said recognition unit.

7. A control method of a measurement apparatus, comprising:
a setting step of setting a dark region on which no light is projected on a portion of a projection pattern for measuring a distance to a measurement target object;
an image capturing step of capturing an image of a measurement target object on which the projection pattern is projected;
an estimation step of estimating disturbance light projected on the measurement target object from the dark region set in the setting step; and
a distance calculation step of measuring the distance to the measurement target object based on the disturbance light estimated in the estimation step and a captured image captured in the image capturing step.

8. A computer-readable storage medium storing a program for controlling a computer to function as respective units of a measurement apparatus according to claim 1.

9. A measurement apparatus, comprising:
a projection unit configured to project a projection pattern for measuring a distance to a measurement target object;
an image capturing unit configured to capture an image of a measurement target object on which the projection pattern is projected;
a setting unit configured to set, as a dark region, a region which falls within a captured image region of said image capturing unit and falls outside a region on which the projection pattern is projected;
an estimation unit configured to estimate disturbance light from the dark region set by said setting unit;
and
a distance measurement unit configured to measure the distance to the measurement target object based the disturbance light estimated by said estimation unit and a captured image captured by said image capturing unit.

10. The apparatus according to claim 9, further comprising:
a correction unit configured to correct the captured image based on the disturbance light estimated by said estimation unit,
wherein said distance measurement unit measures the distance to the measurement target object from the captured image corrected by said correction unit.

11. The apparatus according to claim 9, wherein said estimation unit calculates luminance information indicating disturbance light included in the captured image using the dark region set by said setting unit, and estimates disturbance light of a region including the measurement target object in the captured image.

12. The apparatus according to claim 9, wherein said estimation unit estimates a distribution of disturbance light included in the captured image using a plurality of dark regions set by said setting unit, and estimates disturbance light of a region including the measurement target object in the captured image.

13. The apparatus according to claim 9, wherein said setting unit sets the dark region on a region except for a region where secondary reflected light is cast around the measurement target object in the captured image.

14. The apparatus according to claim 9, further comprising:
a recognition unit configured to recognize the measurement target object from the captured image,
wherein said setting unit sets the dark region on a region except for a region of the measurement target object recognized by said recognition unit.

15. A control method of a measurement apparatus, comprising:
a projection step of projecting a projection pattern for measuring a distance to a measurement target object;
an image capturing step of capturing an image of a measurement target object on which the projection pattern is projected;
a setting step of setting, as a dark region, a region which falls within a captured image region of the image capturing step and falls outside a region on which the projection pattern is projected;
an estimation step of estimating disturbance light from the dark region set in the setting step; and
a distance measurement step of measuring the distance to the measurement target object based on the disturbance light estimated in the estimation step and a captured image captured in the image capturing step.

16. A computer-readable storage medium storing a program for controlling a computer to function as respective units of a measurement apparatus according to claim 9.
